(19) United States
(12) Patent Application Publication
(10) Pub. No.: US 2007/0298368 A1
(43) Pub. Date: Dec. 27, 2007

(54) Measuring Instrument System for Endodontic Length

(75) Inventor: Tae-Kye Nam, Seoul (KR)

Correspondence Address: SUGHRUE MION, PLLC, 2100 PENNSYLVANIA AVENUE, N.W., SUITE 800, WASHINGTON, DC, 20037, US

(73) Assignee: S-DENTI CO., LTD, Seoul (KR)

(21) Appl. No.: 11/569,456

(22) PCT Filed: May 27, 2005
(86) PCT No.: PCT/KR05/01563

§ 371 Date: Nov. 21, 2006

(30) Foreign Application Priority Data
May 28, 2004 (KR) 10-2004-0038548

(51) Int. Cl. A61C 19/00

(52) U.S. Cl. 433/25

(57) ABSTRACT

Disclosed herein is an instrument for measuring an endodontic length, which measures and indicates the distance from a pointed tip of a cutting tool to a root apex in order to prevent the pointed tip of the cutting tool from going over the root apex when a root canal is perforated by the cutting tool for an endodontic treatment of a root canal of a tooth. The endodontic length measuring instrument is equipped inside a unit chair system installed in a consultation room of a dental clinic and allows a monitor mounted on the unit chair system to display a measurement result of the endodontic length, thereby making a medical treatment of a root canal easy, easily providing a measurement result of the endodontic length to a doctor, and displaying treatment and measurement results of the root canal in various and precise ways. The measuring instrument provides a scaled-up image of the remaining distance from the pointed tip of the cutting tool to the root apex when the pointed tip of the cutting tool reaches an area which demands a more precise measurement result, thereby increasing safety and accuracy in perforation of the root canal.

### TECHNICAL FIELD

The present invention relates to an instrument for measuring an endodontic length, which measures and indicates the distance from a pointed-tip of a cutting tool to a root apex in order to prevent the pointed tip of the cutting tool from going over the root apex when a root canal is perforated by the cutting tool such as a file or a reamer to treat the root canal of a calcified or necrotized tooth.

### BACKGROUND ART

An, electronic instrument for measuring an endodontic length is to measure that the instrument reaches the tissue of a root apex using an electrical resistance of the human body, and has been first invented by Sunada in Japan in 1962 (Sunada I: New method for measuring the length or the root canal, J Dent Res 41: 375, 1962). Such measuring instrument has been concepted by the following principle. The principle is that the root apex is a point where resistance comes to 6 kΩ while a cutting tool such as a file or a reamer enters the root canal when a conducting wire connects a patient's lip with the periodontal ligament of the root canal and an electric current of 40 μA is applied to the conducting wire.

However, such electronic instrument has lots of errors, and so, to correct the errors, frequency-based measuring instrument has been invented. The improved measuring instrument minimizes an amount of the electric current used for measurement to 5 μA or so to reduce the patient's inconvenience, and utilizes not one frequency but two different frequencies. When the two different frequencies are used, two different resistances can be obtained at the same time. At this time, a low frequency obtains a high resistance, but a high frequency obtains a low resistance.

The difference between the resistance values due to the different frequencies is maximized at the root apex because the difference is gradually increased when the cutting tool approaches the root apex (place of about 2-3 mm). The measuring instrument calculates and indicates the difference between the resistance values at any time, and informs that an apical foramen comes under a time point when the resistance between the two frequencies reaches the preset value of an apical foramen. There are ENDEX™ (using 1 kHz and 5 kHz) manufactured by OSADA electric company in Japan and ROOT-ZX™ (using 0.4 kHz and 8 kHz) manufactured by MORITA company in Japan as the frequency-based measuring instrument.

Recently, Lee et al. have invented an instrument for measuring various states inside the root canal and automatically correcting errors (Lee Seung Jong, Kim Deok Won and Nam Gi Chang: Study of development and correctness of frequency-based electronic instrument for measuring the endodontic length; Automatic correction type of voltage difference. News Letter by Korea Academy of conservation of dentistry 1997; 22: 809-819).

Such instrument for measuring the endodontic length by adopting the above method is generally provided in the form of a terminal, and is positioned on a table of a unit chair or anther table equipped in a consultation room of a dental clinic in order to measure the endodontic length.

Therefore, when a doctor gives a medical treatment, there is inconvenience due to a lead wire extending to a probe, and there is also inconvenience in that the doctor has to check an LCD of the measuring instrument while seeing the patient's affected part.

Korean Patent No. 159,070 (issued on Aug. 8, 1998) discloses a dental treatment instrument with a, function of measuring an endodontic length. The dental treatment instrument has a cordless type handpiece which reduces inconvenience caused by the lead wire extending to the probe, so as to increase convenience in manipulation and use.

However, in such instrument for measuring the endodontic length provided in the form of the terminal, a display part for displaying a measured result, is provided on the terminal, and so, it is difficult to confirm the measured result of the endodontic length according to the location where the measuring instrument is put.

Meanwhile, the instrument for measuring the endodontic length is to indicate the measured result from the pointed tip of the cutting tool to the root apex in order to prevent the pointed tip of the cutting tool from going over the root apex when the root canal is perforated by the cutting tool. So, the measured result may be a fatal defect of the measuring instrument if it is not minute and exact, and therefore, the indication of the measured result is very important.

Since Sunada′ patent, in the conventional measuring instruments of the endodontic length including the above patents, analog or digital gauge boards indicate a single scale unit. So, the doctor gives medical treatment while moving the cutting tool according to the doctor's sense and experience in a considerable tension in order to prevent the pointed tip of the cutting tool from going over the root apex in a state that the cutting tool approaches the root apex. As a result, the doctor feels severe fatigue in medical treatment, and there is a difference in accuracy of the medical treatment according to the doctor's skill.

Therefore, the conventional measuring instruments increase the doctor's fatigue, and it is difficult to guarantee safety and accuracy in perforation of the root canal.

### DISCLOSURE OF INVENTION

Technical Problem

Accordingly, the present invention has been made in view of the above problems occurring in the prior art, and it is an object of the present invention to a provide an instrument for measuring an endodontic length, which is equipped inside a unit chair system installed in a consultation room of a dental clinic and allows a monitor mounted on the unit chair system to display a measurement result of the endodontic length, thereby making a medical treatment of a root canal easy, easily providing a measurement result of the root canal length to a doctor, and displaying treatment and measurement results of the root canal in various and precise ways.

Furthermore, to solve the problems raised in the conventional measuring instrument of the root canal length with the ‘single scale gauge board’, it is another object of the present invention to provide an instrument for measuring a root canal length, which provides a scaled-up image of the remaining distance from a pointed tip of a cutting tool to a root apex when the pointed tip of the cutting tool reaches an area which demands a more precise measurement result, thereby reducing the doctor's fatigue and tension, and increasing safety and accuracy in perforation of the root canal.

Moreover, it is a further object of the present invention to provide an instrument for measuring an endodontic length, which includes sound signal means for providing a warning sound to the doctor when the pointed tip of the cutting tool approaches the root apex, thereby guaranteeing a more safe treatment.

Technical Solution

A unit chair system includes a chair, a control table having a tool holder for mounting various tools such as a cutting tool for a dental treatment and a control device and for regulating the height of the chair and activating the tools, and display means (monitor) for providing image information to a doctor or a patient.

The unit chair system has an endodontic length measuring module mounting part for mounting an endodontic length measuring module inside the control table in order to receive a resistance value detected by probes, measure the endodontic length and display the measured result. The endodontic length measuring module is mounted inside the control table, the probes of the endodontic length measuring module are drawn to the outside of the control table and mounted on the control table, and a monitor communication interface port is formed on the control table so as to provide a display data outputted from the endodontic length measuring module to the LCD monitor.

The endodontic length measuring module mounting part includes a key button mounting part for exposing key buttons of the endodontic length measuring module to the outside, a probe drawing part for drawing out the probes, and a power supply for providing electric power to the endodontic length measuring module. The endodontic length measuring module is mounted on the endodontic length measuring module mounting part inside the control table, so that a doctor can carry out a medical treatment of the root canal while checking the measurement result of the endodontic length through the monitor installed on the unit chair.

Advantageous Effects

The present invention is integrated with the unit chair system so that the doctor can easily carry out an endodontic treatment. Additionally, by using the monitor, the doctor can easily check the measurement result of the endodontic length during the endodontic treatment. Furthermore, there is little restriction in display information, so that it is possible, to provide information in various ways.

Moreover, the present invention can provide a more detail display screen of the distance from the pointed tip of the cutting tool to the root apex when the pointed tip of the cutting tool approaches the root apex within a predetermined distance, thereby reducing the doctor's fatigue and tension, and increasing safety and accuracy in perforation of the root canal.

In addition, the unit chair system may further includes X-ray capturing means therein, so that the doctor can carry out a more stable endodontic treatment through information compared with X-ray information without movement of the doctor's seat.

Furthermore, the present invention generates the warning sound through, a sound generating part when the pointed tip of the file, approaches the root apex, thereby providing the safe endodontic treatment.

### BRIEF DESCRIPTION OF THE DRAWINGS

FIG. 1 is a view showing a unit chair in which an instrument for measuring an endodontic length according to the present invention is applied.

FIG. 2 is a block diagram showing a structure of an endodontic length measuring module according to the present invention.

FIG. 3 is a view showing an example in which a probe for measuring an endodontic length is mounted.

FIG. 4 is a view showing a state where the root canal is perforated by a file which is a cutting tool.

FIG. 5 is a flow chart showing a process for determining a screen mode which will be displayed on an LCD monitor.

### BEST MODE FOR CARRYING OUT THE INVENTION

Reference will now be made in detail to the preferred embodiments of the present invention, examples of which are illustrated in the accompanying drawings.

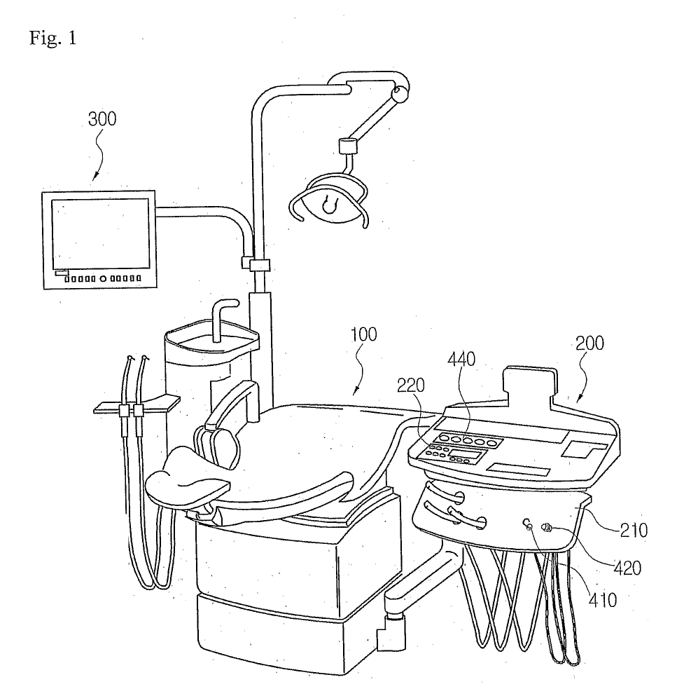

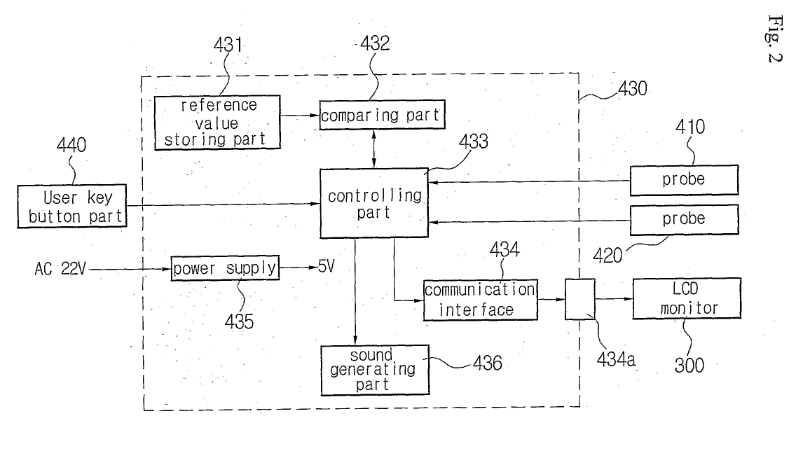

FIG. 1 is a view showing a unit chair system in which an instrument for measuring an endodontic length according to the present invention is applied, and FIG. 2 is a block diagram showing a structure of a control board of an endodontic length measuring module according to the present invention.

The unit chair system includes a patient's chair 100 for a medical treatment, a control table 200 having a tool holder 210 for mounting various tools such as a cutting tool for a dental treatment and a control device and a switch pad 220 for regulating the height of the chair and activating the tools, and an LCD monitor 300 for providing image information to a doctor or a patient.

The unit chair system further includes an endodontic length measuring module mounting part for mounting an endodontic length measuring module 400 inside the control table 200. The endodontic length measuring module 400 mounted on the endodontic length measuring module mounting part includes: probes 410 and 420 connected between the cutting tool and the patient's lip for detecting a resistance value; a control board 430 for measuring a distance from a pointed tip of the cutting tool to a root apex by adopting the resistance value detected from the probes 410 and 420 as an input value, the control board 430 having a control circuit for providing the measurement result to the LCD monitor 300; and a user key button part 440 having key, buttons for allowing a user to control the endodontic length measuring module 400.

The control circuit of the control board 430 includes: a reference value storing part 431 for storing a reference resistance value therein: for displaying a scaled-up measurement result a comparing part 432 for comparing the resistance value detected from the probes 410 and 420 with the reference resistance value provided from the reference value storing part 431; a controlling part 433 for detecting the resistance value from the probes 410 and 420 by applying electric current to the probes 410 and 420, measuring the distance from the pointed, tip of the cutting tool to the root apex through the detected resistance value, generating and outputting a data for indicating the measurement result, and determining, whether a normal display mode or a scaled-up display mode is executed according to the compared result of the comparing part 432 when the display data is generated; a communication interface part 434 having a communication port 434a for outputting the display data generated from the controlling part 433 to the LCD monitor 300; and a power supply 435 for providing electric power for activating the above parts.

The control board 430 of the endodontic length measuring module further includes a sound generating part 436 for generating a warning sound according to control of the controlling part 433 when the pointed tip of the cutting tool approaches the root apex.

The endodontic length measuring module mounting part includes: a key button mounting part for exposing the user key button part 440 of the endodontic length measuring module to the outside of the control table 200; a communication port mounting part having a communication port 434a for connecting a monitor data cable for outputting the measurement result outputted from the endodontic length measuring-module through the LCD monitor 300; a probe drawing part for drawing the probes 410 and 420 to the outside; and a power supply for providing electric power to the endodontic measuring module 400.

Here, the endodontic measuring module, the endodontic measuring module mounting part, and the key button mounting part, the communication port mounting part and the probe drawing part mounted inside the endodontic length measuring module mounting part are not shown in the drawings.

In the unit chair for the dental treatment according to the present invention, the endodontic length measuring module is embedded in the control table 200, and the distance from the pointed tip of the cutting tool to the root apex measured by the endodontic length measuring module is displayed on the LCD monitor 300 mounted on the unit chair, so that the doctor can easily carry out the endodontic treatment of the root canal.

The control table 200 has the control device therein for regulating the height of the chair 100 and controlling activation of various tools such as the cutting tool for the dental treatment. The endodontic measuring module 400 may be mounted in the control table 200 when the control table 200 is manufactured, or may be designed in such a way as to mount the endodontic length measuring module 400 after the endodontic measuring module mounting part 230 for mounting the endodontic measuring module 400 is designed.

The control table 200 has the power supply therein for providing electric power from a utility power source of AC 220V. At this time, the endodontic length measuring module may receive electric power from the power supply of the control table 200, or like this embodiment, has the power supply 435 therein for using electric power by itself.

The endodontic length measuring module mounting part is designed on the control table 200 in such a way that the user key button part 440 of the endodontic length measuring module is exposed to the outside of the control table 200 and the communication port 434a of the communication port mounting part 232 exposes the communication port 434a of the endodontic length measuring module to the outside so as to connect the data cable with the LCD monitor 300.

The user key button part 440 includes key,buttons for allowing the user to control the volume of the warning sound outputted from the sound generating part 436 and accuracy in indication of the endodontic length displayed on the LCD monitor 300.

The communication port 434a comes up to a standard of the communication interface part 434 which will be mounted on the endodontic measuring module, and may consist of a serial communication RS232C or a USB communication interface.

Furthermore, the probe drawing part is, formed in the control table 200 in such a way that the probes 410 and 420 of the endodontic measuring module can be drawn out from the control table 200.

At this time, the drawn, probes 410 and 420 may have fixing means which are positioned on, the tool holder part 210 of the control table 200 or may be fixed to fixing, means which are separately mounted.

The probe 410 or 420 which is connected with the cutting tool, particularly, the file can be connected by a hook type holder or a straight line contact type holder.

The endodontic measuring module is in the form of the control board 430 having the control circuit, and mounted in the endodontic measuring module mounting part.

The control circuit of the control board 430 includes the reference value storing part 431, which stores the reference resistance value, in order to allow the indication of a more precisely scaled-up image of the endodontic length when the distance from the pointed tip of the cutting tool to the root apex is displayed on the LCD monitor 300.

The control circuit of the control board 430 of the endodontic measuring module 400 further includes the sound generating part 436 for generating the warning sound according to control of the controlling part 433 when the pointed tip of the cutting tool approaches the root apex, so that the doctor can carry out the endodontic treatment in safe.

The sound information outputted from the sound generating part 436 may be a sound data such as “buzz˜” or a warning message of a single sentence or a single word.

A using method of the endodontic length measuring instrument applied to the unit chair system is as follows.

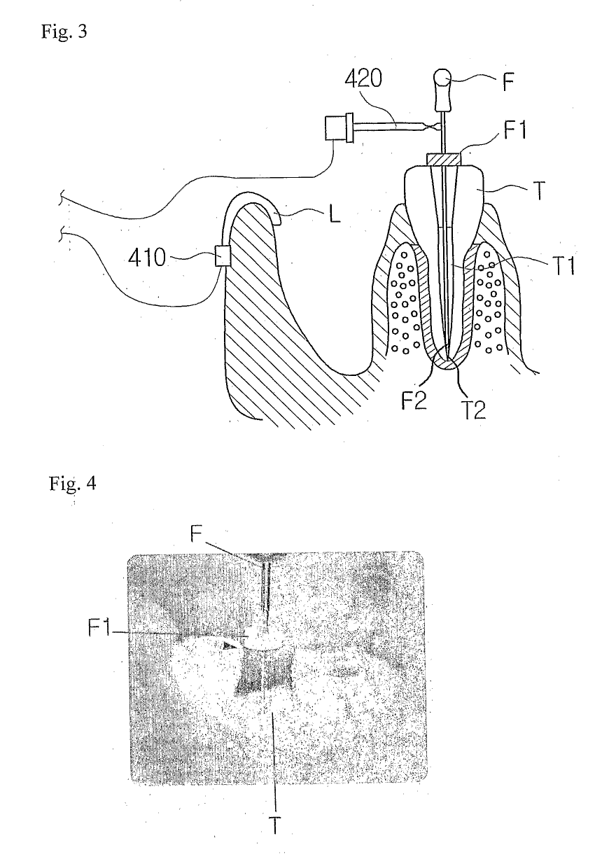

The doctor draws out the probes 410 and 420 from the tool holder 210 of the control table 200, connects the patient's lip (L) to the cutting to (file) (F) as shown in FIG. 3, and carries out the endodontic treatment of the endodontic using the cutting tool (F) connected to the probe 420.

After that, the doctor activates the endodontic length measuring module by selecting the power supply button of the user key button part 440, connects the probe 410 having a clip (forceps) to the patient's lip (L), and then, advances the file (F) to a half of the endodontic length (about 14-18 mm if a tooth is sound). Then, the doctor connects the other probe 420 to the file (F) using a file holder, and carries out the medical treatment of the endodontic while advancing the file little by little.

At this time, the endodontic length measuring module embedded in the control table 200 measures the distance from the pointed tip (F2) of the cutting tool (F) to the root apex (T2) using the resistance value detected through the probes 410 and 420, and displays the measured result on the LCD monitor 300.

Therefore, the doctor can carry out the endodontic treatment of the root canal while checking the LCD monitor 300 installed at a proper position of the chair 100.

Meanwhile, the operation that the endodontic length measuring module measures the endodontic length and the measured result is displayed on the LCD monitor will be described in detail as follows.

Differently from the conventional endodontic length measuring instrument, the present invention scales up and displays the distance from the pointed tip (F2) of the cutting tool (F) to the root apex (T2) on the LCD monitor 300 when the pointed tip (F2) of the cutting tool (F) advances near the root apex (T2).

In FIG. 3, the reference numeral T designates the tooth, T1 designates the root canal, and T2 designates the root apex. In addition, the reference numeral F1 designates a rubber stop, and is to allow the doctor to set a reference point of the tooth with naked eyes as you can see from the photograph of FIG. 4 in detail.

In FIG. 4, the black arrow indicates that the rubber stop (F1) is located at the reference point.

During the endodontic treatment, it is preferable that the root canal (T1) is filled with cleaning solution to prevent dryness thereof.

At this time, it is preferable that the file (F) is not too small, and has a size as large as the doctor feels some resistance inside the root canal (T1).

As the file (F) advances into the root canal (T1), the controlling part 433 of the control board 430 of the endodontic length measuring module detects the reference value through the probes 410 and 420, measures the distance from the pointed tip (F2) of the cutting tool (F) to the root apex (T2) according to the detected resistance value, and transfers the measured result to the LCD monitor 300 through the communication interface part 434 to display it.

At this time, the controlling part, 433 determines whether to execute a screen, which will be displayed on the LCD monitor 300, in a normal mode for displaying a normal image or in an extended mode for displaying a doubly scaled-up image according to a value of the comparing part 432.

The comparing part 432 compares the resistance value detected from the probes 410 and 420 with the reference resistance value set in the reference value storing part 431, and provides the compared result to the controlling part 433 so as to allow the controlling part 433 to execute the extended mode if the detected resistance value exceeds the reference resistance value.

That is, the comparing part 432 continuously determines whether or not the pointed tip (F2) of the cutting tool (F) advances within a predetermined distance from the root apex (T2), and if it advances within the predetermined distance from the root apex (T2), the extended mode is executed.

Furthermore, the controlling part 433 controls the sound generating part 436 to generate the warning sound to inform the doctor of the approach when the pointed tip approaches the root apex (T2).

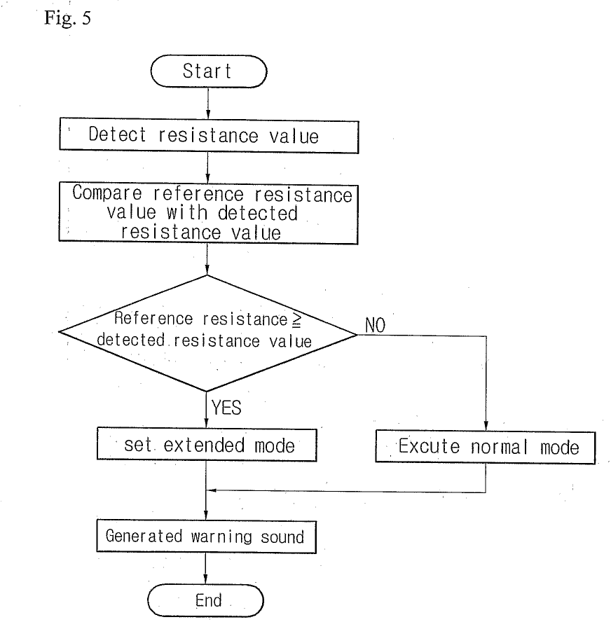

FIG. 5 is a flow chart showing the above process.

It is preferable that a reference point of the scale-up and the warning sound is a location where the distance from the pointed tip (F2) of the cutting toot (F) to the root apex (T2) is 1 mm to 5 mm, particularly, 2 mm to 3 mm to perforate the root canal (T1) accurately and precisely.

If you use an endodontic length measuring method using the present invention, you have to carry out the medical treatment after comparing a measurement value of the instrument with a measurement value calculated after taking a radiograph. At this time, you have to compare the measurement values twice or more in order to prevent an error which may occur, thereby preventing that the file (F) goes over the root apex (T2).

As described above, the screen displayed on the LCD monitor 300 is in the form of a gauge board for indicating the scale doubly, and the form of the displayed screen may be in various ways.

First, at the early stage where the file (F) advances, the gauge board shows a distance from the initial position of the pointed tip of the file to the root apex, but after the file (F) reaches the reference resistance value, the gauge board shows the scaled-up screen.

In a different way, the screen can display the distance from the initial position of the pointed tip (F2) of the file (F) to the root apex (T2) and the extended distance of the root apex (T2) together.

Moreover, it may be considered that the reference resistance values stored in the reference value storing part (431) of the endodontic length measuring module (400) are subdivided in a multistage way, and so, the scaled-up distance is repeatedly displayed whenever the measured resistance values meet with the reference resistance value.

For example, if the distance from the initial position of the pointed tip of the file to the root apex is 10 mm, the first scaled-up reference value is 2 mm, the second scaled-up reference value is 1 mm, and the third scaled-up reference value is 0.5 mm.

At this time, it is possible that the repeatedly scaled-up screen displays only one stage by each stage, displays by two stages or three stages, or displays all stages together.

In the above case, a point of time that the extended mode is executed or the warning sound is generated may be differently set. For example, if the distance of the pointed tip of the cutting tool (F) to the root apex (T2) is 0.5 mm to 2 mm, the sound generating part 436 generates the warning sound.

What is claimed is:

1. An instrument for measuring an endodontic length, which includes a chair, a control table having a tool holder for mounting various tools such as a cutting tool for a dental treatment and a control device for regulating the height of the chair and activating the tools, and, a monitor for providing image information to a doctor or a patient, the measuring instrument comprising:
an endodontic length measuring module mounting part for mounting an endodontic length measuring module inside the control table, wherein the endodontic length measuring module mounted on the endodontic length measuring module mounting part includes: probes connected between the cutting tool and the patient's lip for detecting a resistance value; a control board for measuring a distance from a pointed tip of the cutting tool to a root apex by adopting the resistance value detected from the probes as an input value, the control board having a control circuit for providing the measurement result to the monitor; and a user key button part having key buttons for allowing a user to control the endodontic length measuring module,
wherein, the endodontic length measuring module mounting part includes: a key, button mounting part for exposing the user key button part of the endodontic length measuring module to the outside of the control table; a communication port mounting part having a communication port for connecting a monitor data cable for outputting the measurement result outputted from the endodontic length measuring module through the monitor; and a probe drawing part for drawing the probes to the outside.

2. The instrument for measuring an endodontic length according to claim 1, wherein the control table includes a power supply for supplying electric power to the endodontic length measuring module.

3. The instrument for measuring an endodontic length according to claim 1, wherein the control circuit of the control board of the endodontic length measuring module includes: a reference value storing part for storing a reference resistance value therein for displaying a scaled-up measurement result; a comparing part for comparing the resistance value detected from the probes: with the reference resistance value provided from the reference value storing part; a controlling part for detecting the resistance value from the probes by applying electric current to the probes, measuring the distance from the pointed tip of the cutting tool to the root apex through the detected resistance value, generating and outputting a, data for indicating the measurement result, and determining whether a normal display mode or a scaled-up display mode is executed according to the compared result of the comparing part when the display data is generated; a communication interface part having a communication port for outputting the display data generated from the controlling part to the monitor; and a power supply for providing electric power for activating the above parts.

4. The instrument for measuring an endodontic length according to claim 3, wherein the control board of the endodontic length measuring module further includes a sound generating part for generating a warning sound according to control of the controlling part when the pointed tip of the cutting tool approaches the root apex.

5. The instrument for measuring an endodontic, length according to claim 1, wherein the reference value storing part stores reference resistance values subdivided in a multistage way, whereby the controlling part repeatedly executes an extended mode whenever the measured resistance values meet with the reference resistance value by each stage.

6. The instrument for measuring an endodontic length according to claim 3, wherein the reference value storing part separately sets and stores reference,resistance values for executing the extended mode and generating the warning sound and the controlling part determines whether to execute the extended mode or to generate the warning sound according to a compared result to each reference resistance value.

7. The instrument for measuring an endodontic length according to claim 3, wherein the controlling part controls the monitor to display the scaled-up distance image and a distance image before the scale-up on one screen when the monitor displays the distance from the pointed tip of the cutting tool to the root apex in the extended mode.
